(19) United States
(12) Patent Application Publication
(10) Pub. No.: US 2004/0146632 A1
(43) Pub. Date: Jul. 29, 2004

(54) Effective multi-component penetrating and flavoring marinade

(76) Inventor: Cristina Sayman, Miami, FL (US)

Correspondence Address: Cristina SAYMAN, 11445 S.W. 101 Terrace, Miami, FL, 33176, US

(21) Appl. No.: 10/233,380

(22) Filed: Jan. 23, 2003

(51) Int. Cl. A23L 1/221

(52) U.S. Cl. 426/650

(57) ABSTRACT

This novel marinade, compared with commonly used marinades, synergistically increases the levels of natural flavors as well as added flavors, spices, and food ingredients which are introduced into the meat, fish, or poultry. The marinade contains a synergistic combination of four powerful ingredients: garlic, alcohol (or beer, wine, etc.), vinegar, and monosodium glutamate. These individual ingredients have protein penetrating properties and when used together have even greater penetrating properties so that the natural and added flavors are increased throughout the meat. This penetration allows flavors, spices and other ingredients to be delivered more completely into the proteins of meats, poultry and fish. Various sugars (sucrose, glucose, fructose, etc.) are also used to give a seal, hardened coating or glaze, which forms upon cooking. This coating retains the released natural and added flavors and other ingredients within the meat, fish, and poultry.

### SUMMARY OF THE INVENTION

The present invention is directed to a combination of four penetrating ingredients: beer or wine (alcohol), vinegar, garlic, and monosodium glutamate (MSG). This combination has an extraordinary ability to distribute the spices and flavors throughout the mass of the cooked meat, poultry or fish. The four chemical sources of protein penetrants are the following: alcohol in beer and wine, acetic acid in vinegar, monosodium glutamate (MSG), and several chemical components in garlic, allium sativa, such as aliins (alkylcysteine sulfoxides) and oligosulfide oils. In addition, the use of any sugar source insures the retention of flavors, spices and condiments within the interior of the meat, fish, or poultry.

### SPECIFICATION

The five basic ingredients used in this a unique marinade enhance the natural flavor of all meats, fish, and poultry. These ingredients allow deep penetration as well as sealing of flavors, spices, and food components within the meat, fish, and poultry. The marinade contains four penetrating and tenderizing synergistic ingredients: alcohol (for example, beer and wine), garlic, vinegar, and monosodium glutamate The marinade also contains at least one flavor sealing ingredient: sugars and/or sugar-containing foods. The synergistic meat protein penetrating and sealing mixture is made by mixing the following five components:

(1) beer (or wine) containing alcohol for protein penetration,

(2) chopped garlic (or garlic powder) for protein penetration,

(3) vinegar for protein penetration,

(4) monosodium glutamate, for protein penetration and tenderizing.

(5) sucrose, and other sugars (as well as honey, syrup, and molasses) for flavor sealing and retention.

The weight ratio of the above listed components 1/2/3/4/5 can vary from 10/10/10/1/10 to other desired ratios, except that component 4 should always be maintained at a low level. This mixture, when combined with spices such as onion, pepper, oregano, pimento, salt, soy sauce, and others, can be used both for basting and for overnight marinading in order to impart higher levels of flavors and spices for beef, lamb, pork, poultry, and fish. These basted or marinated meats, fish, and poultry can be barbecued , fried, boiled, microwaved, or baked.

Specific claims for patent application for high penetration marinade

1. This complex multi-component marinade product consists of a unique synergistic combination of several components found to be very effective both in flavor enhancement and flavor retention.

2. This product, unlike any other marinades, uses four protein penetrating and tenderizing materials (garlic, vinegar, beer, and MSG) in combination with one ingredient (sugar) which increases flavor sealing.

3. This product, unlike any other marinades, also assists in the penetration and retention of virtually any desired flavor such as garlic, soy sauce, bacon, cumin, oregano, marjoram, paprika, etc.
